(19) United States
(12) Patent Application Publication
(10) Pub. No.: US 2006/0108449 A1
(43) Pub. Date: May 25, 2006

(54) Pressurized fluid delivery apparatus and nozzle kit

(76) Inventors: Wesley C. Sodemann, Dousman, WI (US); Billy Brandenburg, Horicon, WI (US)

Correspondence Address: MICHAEL BEST & FRIEDRICH, LLP, 100 E WISCONSIN AVENUE, MILWAUKEE, WI, 53202, US

(21) Appl. No.: 10/995,717

(22) Filed: Nov. 22, 2004

(51) Int. Cl. A62C 31/02

(52) U.S. Cl. 239/391; 239/124; 239/390; 239/600; 239/722

(57) ABSTRACT

The present invention provides a nozzle kit for use with a pressurized fluid delivery apparatus having an output device for discharging pressurized fluid. The kit includes first and second distinct nozzles individually connectable with the output device. The first and second nozzles have respective first and second orifices through which the pressurized fluid is dischargeable. The first orifice is larger than the second orifice such that the first and second nozzles output the pressurized fluid at different output pressures and flow rates. The kit also includes a package containing the first and second nozzles.

### FIELD OF THE INVENTION

This invention relates generally to apparatus that provides pressurized fluids such as pressure washers and liquid sprayers.

### BACKGROUND OF THE INVENTION

Pressure washers are well known in the art to provide a highly-pressurized spray of water or other fluid, for cleaning or other purposes. Conventional pressure washers comprise a power unit (e.g., an engine) that drives a pump to provide the pressurized liquid to a rigid wand or other conduit. A regulator is typically coupled to the pump to regulate the output pressure and flow of the water or other fluid from the pump. Nozzles are often coupled to the rigid wand to discharge the pressurized fluid from the rigid wand.

### SUMMARY OF THE INVENTION

The present invention provides, in one aspect, a nozzle kit for use with a pressurized fluid delivery apparatus having an output device for discharging a pressurized fluid. The kit includes first and second distinct nozzles individually connectable with the output device. The first and second nozzles have respective first and second orifices through which the pressurized fluid is dischargeable. The first orifice is larger than the second orifice such that the first and second nozzles output the pressurized fluid at different output pressures and flow rates. The kit also includes a package containing the first and second nozzles.

The present invention provides, in another aspect, a pressurized fluid delivery apparatus including a frame, a power unit supported by the frame, a pump operatively coupled to the power unit and adapted to provide unregulated, pressurized fluid, an output device fluidly connected with the pump to receive the unregulated, pressurized fluid, and a plurality of distinct nozzles individually connectable with the output device to regulate the pressure and flow of the pressurized fluid. At least some of the nozzles have differently-sized orifices such that these nozzles output the pressurized fluid at different output pressures and flow rates.

The present invention provides, in yet another aspect, a kit for use with a pressurized fluid delivery apparatus having an output device. The kit includes a plurality of nozzles individually connectable with the output device. Each of the nozzles has a respective discharge characteristic and a visual indicator associated with each discharge characteristic. The kit also includes a user interface correlating the visual indicators of the respective nozzles with potential user applications of the nozzles.

The present invention provides, in a further aspect, a pressurized fluid delivery apparatus including a frame, a power unit supported by the frame, a pump operatively coupled to the power unit and adapted to provide a pressurized fluid, an output device fluidly connected with the pump to receive the pressurized fluid, and at least one nozzle connectable with the output device. The nozzle has a discharge characteristic and a visual indicator associated with the discharge characteristic. The pressurized fluid delivery apparatus also includes a user interface correlating the visual indicator of the nozzle with at least one potential user application of the nozzle.

The present invention provides, in another aspect, a label for use with a pressurized fluid delivery apparatus having an output device and first and second nozzles individually connectable with the output device. Each of the nozzles has a respective discharge characteristic and a visual indicator associated with each discharge characteristic. The label includes a first side having an adhesive substance thereon to bind to the pressurized fluid delivery apparatus, and a second side having a user interface disposed thereon. The user interface includes a data field corresponding to each of the first and second nozzles. Each of the data fields identifies at least one potential user application associated with the respective nozzle.

Other features and aspects of the present invention will become apparent to those skilled in the art upon review of the following detailed description, claims and drawings.

### BRIEF DESCRIPTION OF THE DRAWINGS

In the drawings, wherein like reference numerals indicate like parts:

FIG. 1 is a perspective view of a pressurized fluid delivery apparatus of the present invention.

FIG. 2 is an enlarged view of a portion of the pressurized fluid delivery apparatus of FIG. 1, illustrating a plurality of nozzles.

FIG. 3 is a perspective view of a package containing a plurality of nozzles.

FIG. 4 is a plan view of a user interface for the plurality of nozzles of FIG. 3.

FIG. 5 is a perspective view of another construction of a user interface for the plurality of nozzles of FIG. 3.

Before any features of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including”, “having”, and “comprising” and variations thereof herein is meant to encompass the items listed thereafter and equivalents thereof as well as additional items. The use of letters to identify elements of a method or process is simply for identification and is not meant to indicate that the elements should be performed in a particular order.

### DETAILED DESCRIPTION

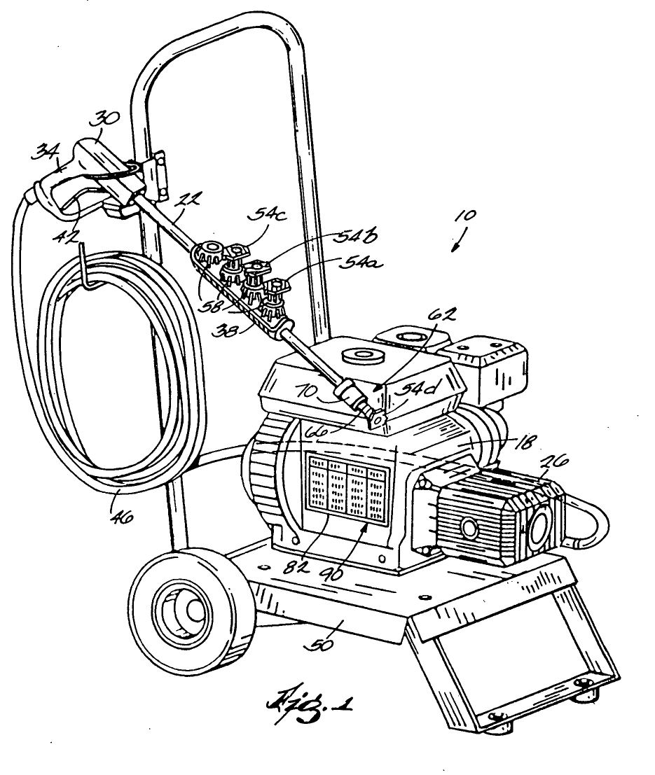

FIG. 1 illustrates a pressurized fluid delivery apparatus, or a pressure washer 10, incorporating a nozzle kit 14 of the present invention. The pressure washer 10 includes a power unit 18 to provide a pressurized fluid to an output device in the form of a rigid conduit or wand 22. The power unit 18 can be an engine, electric motor, or other power unit. A pump 26 is operatively coupled to the power unit 18 to provide the pressurized fluid. As understood in the art, the pump 26 can receive a supply of low-pressure fluid, pressurize the fluid, and discharge the pressurized fluid to the wand 22. In the illustrated construction, the pressure washer 10 does not utilize a regulator to regulate the pressure and flow of the fluid from the pump 26. Therefore, unregulated, pressurized fluid is discharged to the wand 22.

The wand 22 is coupled to a gun assembly 30 and acts as an extension to the gun assembly 30. The gun assembly 30 includes a hand grip 34 for a user to grasp with one hand, and the wand 22 includes a handle 38 to grasp with the other hand. A trigger 42 is located near the hand grip 34 to allow the user to selectively operate the gun assembly 30. The trigger 42 is coupled to a valve (not shown) inside the gun assembly 30. When the trigger 42 is pulled, the valve opens to allow the pressurized fluid to flow through the valve.

The gun assembly 30 is fluidly connected with the pump 26 by a flexible hose 46, which allows the power unit 18 and pump 26 to remain in one place while the user moves around and operates the gun assembly 30. Any number of conventional fluid couplings may be used to fluidly connect and secure the hose 46 to the pump 26 and to the gun assembly 30, respectively. Further, the power unit 18 and pump 26 may be transportable by a wheeled frame or cart 50.

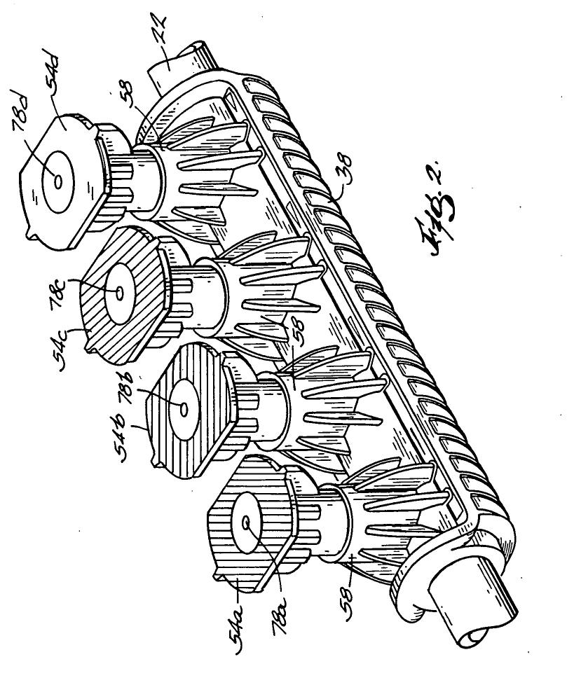

FIG. 1 illustrates a fluid accessory in the form of a nozzle 54a, 54b, 54c, or 54d coupled to the wand 22. The pressurized fluid exits the wand 22 via the nozzle 54a, 54b, 54c, or 54d. FIGS. 1 and 2 illustrate the handle 38 including a plurality of bosses 58 that are sized and shaped to receive one or more nozzles 54a, 54b, 54c, or 54d for storage. In the illustrated construction, a quick-disconnect assembly 62 is used to couple the nozzle 54a, 54b, 54c, or 54d to the wand 22. The quick-disconnect assembly 62 includes a male fitting 66 coupled to the nozzle 54a, 54b, 54c, or 54d and a female fitting 70 coupled to the wand 22. In some constructions, the male fitting 66 may be integrally formed with the nozzle 54a, 54b, 54c, or 54d.

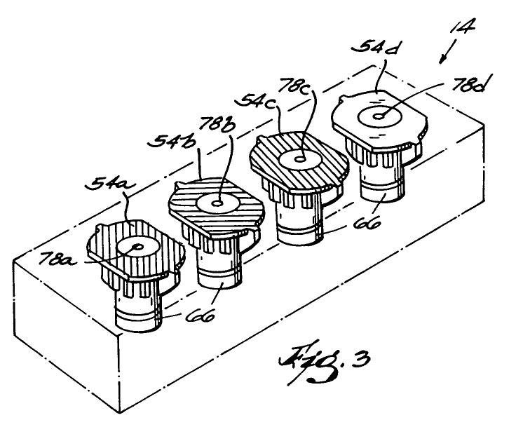

FIG. 3 illustrates the nozzle kit 14 of the present invention. The nozzle kit 14 includes at least two distinct nozzles, such as four nozzles 54a, 54b, 54c, 54d that are individually connectable with the wand 22. The nozzle kit 14 also includes a package 74 containing the plurality of nozzles, such as nozzles 54a, 54b, 54c, 54d. The package 74 may be made from any of a number of different materials, including, for example, plastic and cardboard. Alternatively, other materials may be used to make the package 74.

The nozzles 54a, 54b, 54c, 54d are configured to exhibit respective different discharge characteristics of the pressurized fluid. Specifically, the nozzles 54a, 54b, 54c, 54d include respective differently-sized orifices 78a, 78b, 78c, 78d to discharge the pressurized fluid at different output pressures. The differently-sized orifices 78a, 78b, 78c, 78d of the respective nozzles 54a, 54b, 54c, 54d define different flow areas. For example, the nozzles 54a, 54b, 54c, 54d may include respective orifices 78a, 78b, 78c, 78d having nominal diameters of 0.025″, 0.035″, 0.045″, and 0.055″, which yield progressively larger flow areas. Alternatively, the nozzles 54a, 54b, 54c, 54d may be configured with respective orifices 78a, 78b, 78c, 78d having any of a number of different nominal diameters. Further, the nozzles 54a, 54b, 54c, 54d may include respective orifices having non-circular shapes, provided the orifices define different flow areas.

When the nozzles 54a, 54b, 54c, 54d are used with the pressure washer 10, nozzles 54a, 54b having relatively small orifices 78a, 78b yield higher output pressures and lower flow rates, while nozzles 54c, 54d having relatively large orifices 78c, 78d yield lower output pressures and higher flow rates. As such, the nozzles 54a, 54b, 54c, 54d are operable to regulate the output pressure and flow of the discharged pressurized fluid. Thus, the user may reconfigure the pressure washer 10 by merely changing the nozzles 54a, 54b, 54c, 54d to achieve a desired output pressure and flow of the discharged pressurized fluid according to a particular user application. Conventional pressure washers often require the user to adjust a pressure regulator to control the output pressure and flow of the discharged pressurized fluid, which can be troublesome for a user to achieve repeatable settings between adjustments. The combination of the pressure washer 10 and the nozzle kit 14 of the present invention allows the user to achieve repeatable settings of output pressure and flow of the discharged pressurized fluid between adjustments.

The nozzles 54a, 54b, 54c, 54d may be also be configured to exhibit other discharge characteristics of the pressurized fluid. For example, in addition to providing respective different output pressures, the nozzles 54a, 54b, 54c, 54d may also shape the discharged pressurized fluid into a spray pattern desirable for performing particular cleaning applications. For example, one of the nozzles 54a, 54b, 54c, 54d may be configured to provide a wide-angle spray pattern to clean a large surface, while another nozzle 54a, 54b, 54c, 54d may be configured to provide a narrow-angle spray pattern to clean a small surface.

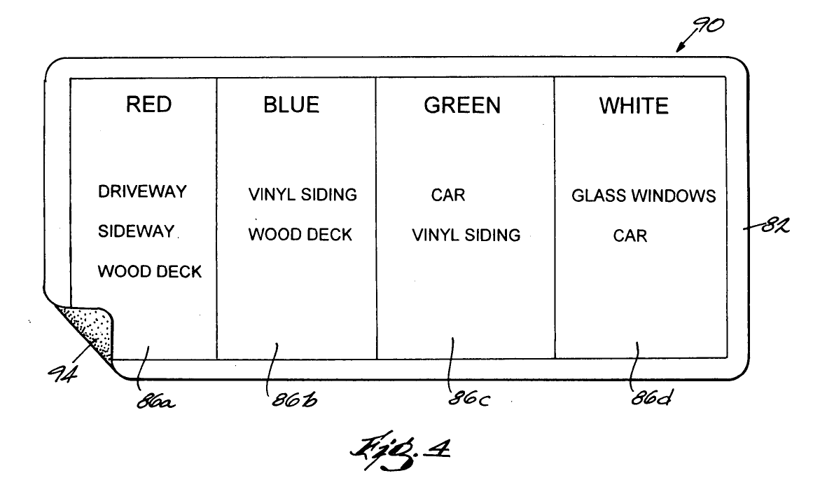

The nozzle kit 14 may also include a user interface 82 for the user of the pressure washer 10 to reference in determining which of the nozzles 54a, 54b, 54c, 54d to use for a particular user application. As shown in FIG. 4, the user interface 82 includes a plurality of data fields 86a, 86b, 86c, 86d corresponding to the respective nozzles 54a, 54b, 54c, 54d. In the illustrated construction, the data fields 86a, 86b, 86c, 86d are arranged as columns. Alternatively, the data fields 86a, 86b, 86c, 86d may be arranged as rows, as separate text boxes, or in any other manner. Also, in the illustrated construction, the user interface 82 includes four data fields 86a, 86b, 86c, 86d corresponding to the four nozzles 54a, 54b, 54c, 54d of the nozzle kit 14. Alternatively, the nozzle kit 14 may include any number of nozzles, and the user interface 82 may include a corresponding number of data fields associated with the nozzles.

Each of the data fields 86a, 86b, 86c, 86d identifies potential user applications for the nozzle 54a, 54b, 54c, 54d associated with the data field 86a, 86b, 86c, 86d. For example, the data fields 86a, 86b may be associated with relatively high-pressure/lower flow rate nozzles 54a, 54b and may include potential user applications that would benefit from using the relatively high-pressure/lower flow rate nozzles 54a, 54b. For example, data fields 86a, 86b list potential user applications of spraying a driveway, sidewalk, wood deck, and vinyl siding. Similarly, the data fields 86c, 86d may be associated with the relatively low-pressure/higher flow rate nozzles 54c, 54d and may include potential user applications that would benefit from using the relatively low-pressure/higher flow rate nozzles 54c, 54d. For example, data fields 86c, 86d list potential user applications of spraying a car, vinyl siding, and glass windows. As shown in FIG. 4, more than one nozzle 54a, 54b, 54c, 54d may be associated with the same potential user application. For example, either of the nozzles 54a, 54b may be associated with spraying a wood deck, while either of the nozzles 54b, 54c may be associated with spraying vinyl siding.

With reference to FIG. 3, each of the nozzles 54a, 54b, 54c, 54d includes a visual indicator associated with the particular discharge characteristic of the nozzle 54a, 54b, 54c, 54d. In the illustrated construction, the nozzles 54a, 54b, 54c, 54d are differently colored to correlate the discharge characteristics of the nozzles 54a, 54b, 54c, 54d with the data fields 86a, 86b, 86c, 86d in the user interface 82 (see FIG. 4). As shown in the example user interface 82, the nozzles 54a, 54b, 54c, 54d are colored red, blue, green, and white to provide a visual indicator to the user which nozzle 54a, 54b, 54c, 54d is associated with which data field 86a, 86b, 86c, 86d. Alternatively, other colors may be used with the nozzles 54a, 54b, 54c, 54d.

Further, other visual indicators may be used with the nozzles 54a, 54b, 54c, 54d to allow a user to correlate a particular nozzle 54a, 54b, 54c, 54d with a particular data field 86a, 86b, 86c, 86d. For example, the nozzles 54a, 54b, 54c, 54d may be labeled with symbols, letters, words, and/or numbers to provide a visual indicator to the user which nozzle 54a, 54b, 54c, 54d is associated with which data field 86a, 86b, 86c, 86d. Such symbols, letters, words, and/or numbers may be integrally formed with the nozzles 54a, 54b, 54c, 54d, or may be printed on stickers or labels that are applied to the nozzles 54a, 54b, 54c, 54d. The nozzles 54a, 54b, 54c, 54d may also be configured with unique shapes to provide a visual indicator to the user which nozzle 54a, 54b, 54c, 54d is associated with which data field 86a, 86b, 86c, 86d.

As shown in FIG. 4, the user interface 82 is disposed on one side of a label 90, and an adhesive substance 94 is disposed on an opposite side of the label 90. Using the adhesive substance 94, the label 90 may be applied to a portion of the pressure washer 10 (e.g., the cart 50, power unit 18, pump 26, gun assembly 30, or the wand 22) for quick reference by the user. For example, FIG. 1 illustrates the label 90 applied to the power unit 18.

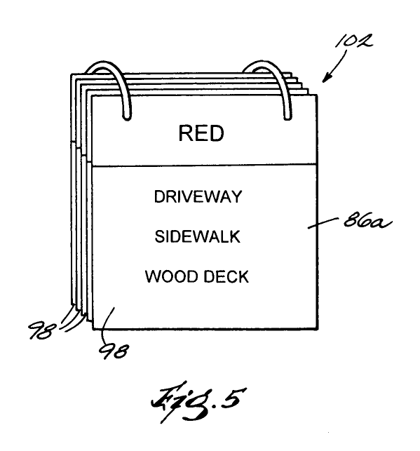

Alternatively, the user interface 82 may be disposed on one or more laminated sheets 98 (see FIG. 5). Such laminated sheets 98 may be coupled to the pressure washer 10 by a chain, rope, or other tether to allow the user to reference the user interface 82 without regard to misplacing or loosing the laminated sheets 98. In addition, the user interface may be configured as a flip book 102 including two or more of the laminated sheets 98. Each sheet 98 may include at least one data field 86a, 86b, 86c, 86d associated with a particular nozzle 54a, 54b, 54c, 54d, such that the user may reference a particular sheet 98 in the flip book 102 to view potential user applications associated with a particular nozzle 54a, 54b, 54c, 54d. Such a flip book 102 may also be coupled to the pressure washer 10 by a chain, rope, or other tether.

Various aspects of the present invention are set forth in the following claims.

We claim:

1. A nozzle kit for use with a pressurized fluid delivery apparatus having an output device for discharging pressurized fluid, the kit comprising:
first and second distinct nozzles individually connectable with the output device, the first and second nozzles having respective first and second orifices through which the pressurized fluid is dischargeable, the first orifice being larger than the second orifice such that the first and second nozzles output the pressurized fluid at different output pressures; and
a package containing the first and second nozzles.

2. The nozzle kit of claim 1, wherein the first nozzle includes a first visual indicator, and wherein the second nozzle includes a second visual indicator that is different from the first visual indicator.

3. The nozzle kit of claim 2, wherein the first and second visual indicators include different colors formed on the first and second nozzles.

4. The nozzle kit of claim 2, further comprising a user interface correlating the first and second visual indicators with potential user applications of the first and second nozzles.

5. The nozzle kit of claim 4, wherein the user interface includes a respective data field for each of the first and second visual indicators, and wherein each of the data fields identifies at least one potential user application associated with the respective nozzle.

6. The nozzle kit of claim 4, wherein the user interface includes a label having an adhesive substance thereon to adhere to the pressurized fluid delivery apparatus.

7. The nozzle kit of claim 4, wherein the user interface includes at least one sheet displaying potential user applications associated with at least one of the first and second nozzles.

8. The nozzle kit of claim 4, wherein the user interface includes a flip book having a first sheet and a second sheet, wherein the first sheet displays potential user applications associated with the first nozzle, and wherein the second sheet displays potential user applications associated with the second nozzle.

9. The nozzle kit of claim 1, wherein the first nozzle has a different color than the second nozzle.

10. A pressurized fluid delivery apparatus, comprising:
a frame;
a power unit supported by the frame;
a pump operatively coupled to the power unit and adapted to provide unregulated, pressurized fluid;
an output device fluidly connected with the pump to receive the unregulated, pressurized fluid; and
a plurality of nozzles individually connectable with the output device to regulate the pressure and flow of the pressurized fluid, the nozzles having respective differently-sized orifices such that each nozzle outputs the pressurized fluid at a different output pressure.

11. The pressurized fluid delivery apparatus of claim 10, wherein each of the nozzles includes a visual indicator.

12. The pressurized fluid delivery apparatus of claim 11, wherein the visual indicators of the respective nozzles include different colors on the respective nozzles.

13. The pressurized fluid delivery apparatus of claim 11, further comprising a user interface correlating the visual indicators of the respective nozzles with potential user applications of the nozzles.

14. The pressurized fluid delivery apparatus of claim 13, wherein the user interface includes a plurality of data fields corresponding to the visual indicators of the respective nozzles, each of the data fields identifying at least one potential user application associated with the respective nozzle.

15. The pressurized fluid delivery apparatus of claim 13, wherein the user interface includes a label having an adhesive substance thereon to adhere to at least one of the frame, power unit, pump, and the output device.

16. The pressurized fluid delivery apparatus of claim 13, wherein the user interface includes at least one sheet displaying potential user applications associated with at least one of the nozzles.

17. The pressurized fluid delivery apparatus of claim 13, wherein the user interface includes a flip book having a plurality of sheets, wherein the respective sheets display potential user applications associated with the respective nozzles.

18. The pressurized fluid delivery apparatus of claim 10, wherein each of the plurality of nozzles has a different color.

19. A kit for use with a pressurized fluid delivery apparatus having an output device, the kit comprising:
a plurality of nozzles individually connectable with the output device, each of the nozzles having a respective discharge characteristic and a visual indicator associated with each discharge characteristic; and
a user interface correlating the visual indicators of the respective nozzles with potential user applications of the nozzles.

20. The kit of claim 19, wherein the visual indicators of the respective nozzles include different colors formed on the respective nozzles.

21. The kit of claim 19, wherein the nozzles have respective differently-sized orifices to provide the respective discharge characteristics of the nozzles.

22. The kit of claim 19, wherein the nozzles discharge fluid at respective different output pressures, and wherein the visual indicators of the respective nozzles correspond to the output pressures of the respective nozzles.

23. The kit of claim 19, wherein the discharge characteristic of each nozzle includes at least one of an output pressure, a flow rate, and a spray angle.

24. The kit of claim 19, further comprising a package containing the plurality of nozzles and the user interface.

25. The kit of claim 19, wherein the user interface includes a plurality of data fields corresponding to the visual indicators of the respective nozzles, each of the data fields identifying at least one potential user application associated with the respective nozzle.

26. The kit of claim 19, wherein the user interface includes a label having an adhesive substance thereon to adhere to the delivery apparatus.

27. The kit of claim 19, wherein each of the plurality of nozzles has a different color.

28. The kit of claim 19, wherein the user interface includes at least one sheet displaying potential user applications associated with at least one of the nozzles.

29. The kit of claim 19, wherein the user interface includes a flip book having a plurality of sheets, wherein the respective sheets display potential user applications associated with the respective nozzles.

30. A pressurized fluid delivery apparatus, comprising:
a frame;
a power unit supported by the frame;
a pump operatively coupled to the power unit and adapted to provide a pressurized fluid;
an output device fluidly connected with the pump to receive the pressurized fluid;
at least one nozzle connectable with the output device, the nozzle having a discharge characteristic and a visual indicator associated with the discharge characteristic; and
a user interface correlating the visual indicator of the nozzle with at least one potential user application of the nozzle.

31. The pressurized fluid delivery apparatus of claim 30, wherein the visual indicator of the at least one nozzle includes a color on the at least one nozzle.

32. The pressurized fluid delivery apparatus of claim 30, wherein the at least one nozzle discharges fluid at an output pressure, and wherein the visual indicator corresponds to the output pressure of the at least one nozzle.

33. The pressurized fluid delivery apparatus of claim 30, wherein the discharge characteristic of the at least one nozzle includes at least one of an output pressure, a flow rate, and a spray angle.

34. The pressurized fluid delivery apparatus of claim 30, further comprising a package containing the at least one nozzle and the user interface.

35. The pressurized fluid delivery apparatus of claim 30, wherein the user interface includes a data field corresponding to the visual indicator, the data field identifying at least one potential user application associated with the at least one nozzle.

36. The pressurized fluid delivery apparatus of claim 30, wherein the user interface includes a label having an adhesive substance thereon to adhere to at least one of the frame, power unit, pump, and the output device.

37. The pressurized fluid delivery apparatus of claim 30, wherein the at least one nozzle includes first and second distinct nozzles individually connectable with the output device, the first and second nozzles having respective first and second orifices through which the pressurized fluid is dischargeable, the first orifice being larger than the second orifice such that the first and second nozzles output the pressurized fluid at different output pressures.

38. The pressurized fluid delivery apparatus of claim 30, wherein the user interface is interconnected to the delivery apparatus to be disposed for reference by the user during operation of the delivery apparatus.

39. The pressurized fluid delivery apparatus of claim 30, wherein the user interface includes at least one sheet displaying potential user applications associated with the at least one nozzle.

40. A label for use with a pressurized fluid delivery apparatus having an output device and first and second nozzles individually connectable with the output device, each of the nozzles having a respective discharge characteristic and a visual indicator associated with each discharge characteristic, the label comprising:
a first side having an adhesive substance thereon to bind to the pressurized fluid delivery apparatus; and
a second side having a user interface disposed thereon, the user interface including a data field corresponding to each of the first and second nozzles, each of the data fields identifying at least one potential user application associated with the respective nozzle.
